(19) United States
(12) Patent Application Publication
(10) Pub. No.: US 2008/0152325 A1
(43) Pub. Date: Jun. 26, 2008

(54) Apparatus and method for controlling BLDC motor

(75) Inventors: Hun Yub Bae, Gwangju (KR); Hamaoka Koji, Gwangju (KR); Han Joo Yoo, Gwangju (KR); Pyeong Ki Park, Gwangju (KR); Jeong Ho Seo, Gwangju (KR); Kwang Kyo Oh, Gwangju (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/984,312

(22) Filed: Nov. 15, 2007

(30) Foreign Application Priority Data
Dec. 21, 2006 (KR) 10-2006-0132165

(51) Int. Cl. H02P 7/29

(52) U.S. Cl. 388/811

(57) ABSTRACT

Disclosed are an apparatus and a method of controlling a BLDC motor, including a controller to determine whether the PWM duty of the BLDC motor in driving is desirable, and performing compensation and control processes for the BLDC motor according to the determination result, through a phase voltage measuring scheme, when controlling the operation of the BLDC motor by adjusting voltage applied to three-phase coils of a stator of the BLDC motor.

### CROSS-REFERENCE TO RELATED APPLICATIONS

This application claims the benefit of Korean Patent Application No. 2006-132165, filed on Dec. 21, 2006, in the Korean Intellectual Property Office, the disclosure of which is incorporated herein by reference.

### BACKGROUND OF THE INVENTION

1. Field of the Invention

The present invention relates generally to an apparatus and a method of controlling a brushless DC (BLDC) motor, in which the manufacturing cost of the apparatus can be reduced, the operation mode of the BLDC motor can be stably controlled, and reliability of the BLDC motor can be improved by reducing noise derived from the driving speed error of the BLDC motor.

To this end, the present invention suggests an apparatus and a method of controlling the BLDC motor, which enable a controller to determine whether the PWM duty of the BLDC motor in driving is desirable, and then perform compensation and control processes for the BLDC motor according to the determination result, through a phase voltage measuring scheme, when controlling the operation of the BLDC motor by adjusting voltage applied to three-phase coils of a stator of the BLDC motor.

2. Description of the Related Art

Generally, in order to compensate for the rotational speed error of a BLDC motor, methods of compensating for the rotational speed error of the BLDC motor in driving by detecting the speed of the BLDC motor have been mainly used. Among these methods, an operation of applying three-phase voltage to a stator is typically employed. According to this operation, after obtaining zero cross points (hereinafter, referred to as “ZCPs”) of electromotive force induced into a three-phase stator, the speed of the BLDC motor is calculated based on a time interval t between the obtained ZCPs (see, FIG. 2), thereby allowing the controller to adjust a pulse width modulation (PWM) duty input to an inverter such that the BLDC motor operates at a desired speed. In this manner, the speed of the BLDC motor is compensated and controlled.

However, in order to employ the conventional three-phase voltage scheme, a comparator must be provided in the form of circuits to find time points of the ZCPs, and a controller must periodically determine position detection information of a three-phase rotor, resulting in a burdensome control process. In addition, there occur speed measurement errors of the motor due to noises in a high-speed operational mode. The speed measurement and control errors may exert bad influences on the reliability and the manufacturing costs of products equipped with the BLDC motor.

FIGS. 1 and 2 are a block diagram showing a BLDC motor driving device and graphs showing a phase detecting waveform used for measuring a motor driving speed by detecting position information of a rotor of the BLDC motor through a conventional three-phase voltage scheme using a back electromotive force.

In FIG. 1, the BLDC motor driving device includes representative blocks such as a rectifier 10, an inverter 11, a comparator 13, and a controller 14. The rectifier 10 rectifies and smooths AC power so as to supply DC power. The inverter 11 converts the DC power supplied in the rectifier 10 into three-phase AC power (generally, including U-phase AC power, V-phase power, and W-phase power) in the shape of a pulse, which has a predetermined variable frequency, to be input to the BLDC motor 12. In addition, the inverter 11 mainly includes switching elements to respond to a PWM signal in the form of an on/off signal provided from the controller 14 and then provide an amplified PWM signal having timing the same as that of the PWM signal to a stator of the BLDC motor 12. The comparator 13 compares three-phase voltage (U, V, and W voltage) provided to the BLDC motor 12 with a reference voltage (DC power) to supply three-phase position detection signals (see, FIG. 2) to the controller 14. The reference voltage may vary according to the power used in the driving device or design requirements.

The controller 14 recognizes zero cross points (ZCPs) from the three-phase position detection signal and obtains the speed of the BLDC motor in driving from an interval between the ZCPs (see reference character t of FIG. 2). The controller 14 adjusts a PWM duty based on the obtained driving speed of the BLDC motor such that the BLDC motor is driven at a desired speed. In addition, the controller 14 performs an overall control algorithm in an electronic device.

### SUMMARY OF THE INVENTION

Accordingly, it is an aspect of the present invention to solve the above-mentioned problems occurring in the conventional three-phase voltage scheme. It is another aspect of the present invention to provide an apparatus and a method for controlling a BLDC motor, which employ a phase voltage measuring scheme to determine suitability of PWM Duty of the BLDC motor, and to compensate and control the BLDC motor according to the determination result.

Additional aspects and/or advantages of the invention will be set forth in part in the description which follows and, in part, will be apparent from the description, or may be learned by practice of the invention.

The foregoing and/or other aspects are achieved by providing an apparatus controlling a brushless DC motor, the apparatus including a rectifier supplying DC power, an inverter converting the DC power into AC power having a variable frequency in a shape of a pulse, and a controller controlling the inverter, wherein suitability of a pulse width modulation duty relative to a driving speed of the brushless DC motor is determined with respect to voltage applied to a stator of the brushless DC motor based on a phase voltage measuring scheme of measuring voltage, and compensation and control processes for the brushless DC motor are performed according to the determination result.

In addition, the phase voltage measuring operation compensates and controls the pulse width modulation duty by measuring phase voltage, and the controller calculates a phase voltage ratio Rv in order to determine a driving speed of the brushless DC motor in driving, and compares the phase voltage ratio Rv with a speed constant Kp.

Further, the controller measures voltage twice per period (360 degrees) and divides a lower phase voltage value by a higher phase voltage value, thereby calculating the phase voltage ratio Rv. For example, the voltage may be measured at 90 and 180 degrees.

In addition, the controller determines that the pulse width modulation duty has the large value, and the brushless DC motor is driven at a speed faster than a desired speed, when the phase voltage ratio Rv is smaller than the speed constant Kp, and determines that the pulse width modulation duty has the small value, and the brushless DC motor is driven at a speed slower than the desired speed when the phase voltage ratio Rv is greater than the speed constant Kp.

Further, the controller performs the compensation and control processes by reducing the pulse width modulation duty when the pulse width modulation duty has a large value, and increasing the pulse width modulation duty when the pulse width modulation duty has a small value, such that the phase voltage ratio Rv is equal to the speed constant Kv.

The foregoing and/or other aspects of the present invention are achieved by providing a method of controlling a brushless DC motor in a system including a rectifier supplying DC power, an inverter converting the DC power into AC power having a variable frequency in a from of a pulse, and a controller performing a control process, the method including measuring a phase voltage applied to a stator of the brushless DC motor, calculating a voltage ratio Rv from the measured phase voltage, determining a pulse width modulation duty comprising comparing the voltage ratio Rv with a constant speed Kp, and compensating and controlling the pulse width modulation duty according to the determining.

The operation of the measuring of the phase voltage, the phase voltage is measured at 90 and 180 degrees for one period (360 degrees). In the operation of calculating the voltage ratio Rv, the voltage ratio Rv is calculated by dividing a voltage value at 180 degrees by a voltage value at 90 degrees.

The operation of determining the pulse width modulation duty comprises determining that the pulse width modulation duty input to the inverter is greater than a pulse width modulation duty for a desired driving speed of the brushless DC motor when the phase voltage ratio Rv is smaller than the speed constant Kp, and determining that the pulse width modulation duty input to the inverter is smaller than the pulse width modulation duty for the desired driving speed of the brushless DC motor when the phase voltage ratio Rv is greater than the speed constant Kp.

In the operation of compensating the pulse width modulation duty, the controller decreases the pulse width modulation duty when the pulse width modulation duty has a large value, and increases the pulse width modulation duty when the pulse width modulation duty has a small value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the structure of a conventional BLDC motor driving device for obtaining a position detection signal from three-phase voltage;

FIG. 2 shows graphs representing waveforms of a phase detection signal according to a conventional three-phase voltage scheme when a motor driving speed is determined;

FIG. 3 is a block diagram showing a BLDC motor driving device for determining a PWM duty according to one embodiment of the present invention;

FIG. 4 shows graphs representing phase waveforms input to a controller in order to determine a PWM duty according to one embodiment of the present invention;

FIG. 5 shows graphs representing phase waveforms according to the change of a conduction interval of a BLDC motor;

FIGS. 6A to 6C show waveforms according to voltage at a measurement phase and a driving speed of a BLDC motor; and

FIG. 7 shows phase distribution according to phases of a three-phase stator of a BLDC motor when a speed constant Kp is 0.5.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, exemplary embodiments of the present invention will be described in detail with reference to the accompanying drawings.

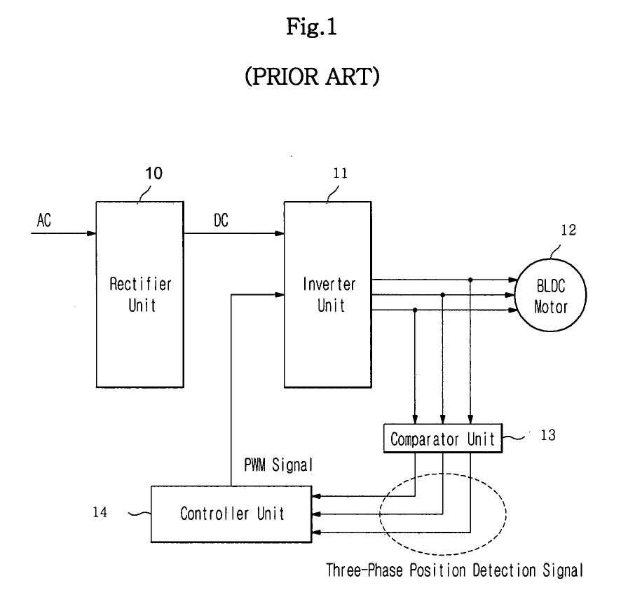

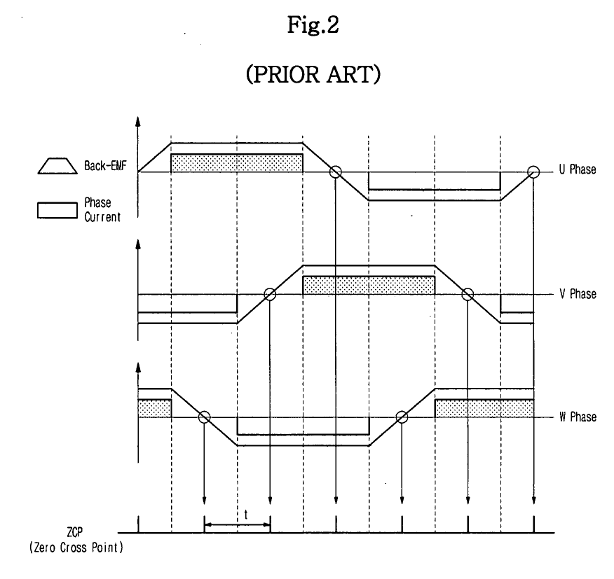

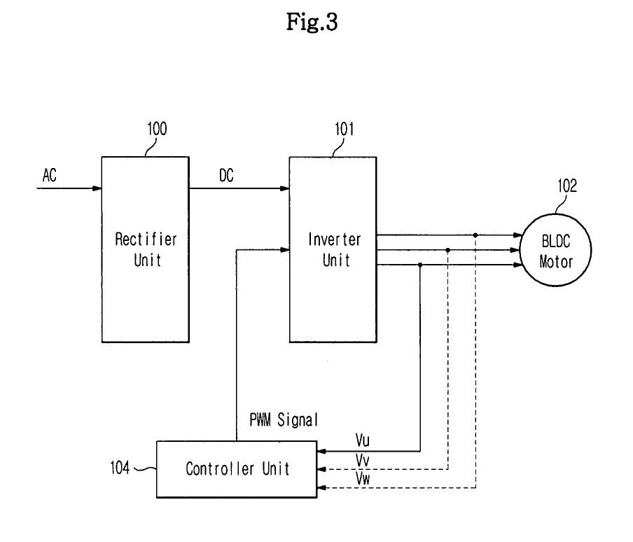

FIG. 3 is a block diagram showing a BLDC motor driving device adopting a phase voltage measuring scheme in order to drive a BLDC motor 102 at a desired speed according to one embodiment of the present invention. The BLDC motor 102 receives three-phase AC power from an inverter 1-1, which receives a DC signal resulting from an AC signal rectified by rectifier 100. When comparing FIG. 1 with FIG. 3, the comparator 13 generating a phase detection signal shown in FIG. 1 is omitted from FIG. 3.

In addition, suitability of a PWM duty can be determined based on one of three-phase voltages, and compensation and control processes can be performed according to the determination result. Accordingly, it can be understood from FIG. 3 that manufacturing costs of the BLDC motor driving device are reduced, and the control mechanism of a controller 104 can be simplified.

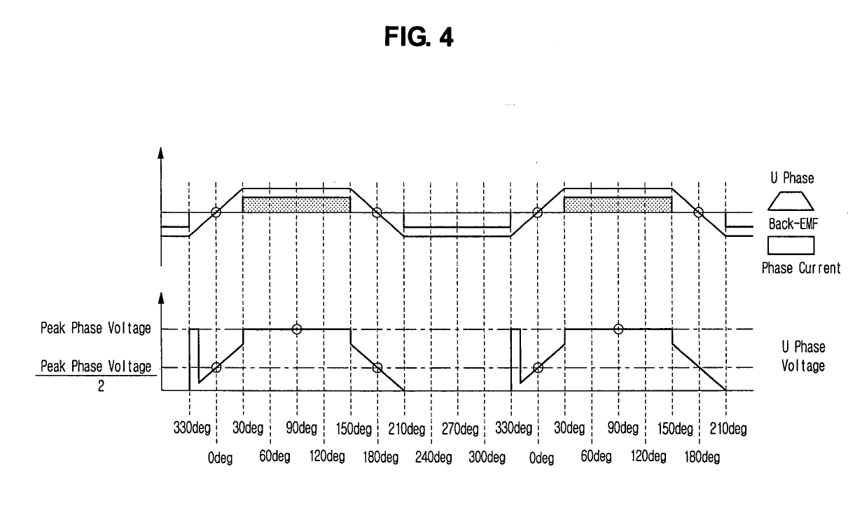

FIG. 4 shows graphs representing a phase waveform input to the controller 104 in order to determine an input PWM duty according to one embodiment of the present invention. The BLDC motor 102 rotates by 360 degrees for one period, and a half of the maximum phase voltage value is shown at 0 and 180 degrees in a U phase voltage signal. Although the half of the maximum phase voltage value is shown in a predetermined phase range, the maximum phase voltage value is measured at 90 degrees corresponding to a midpoint of the phase range as shown in the phase waveform.

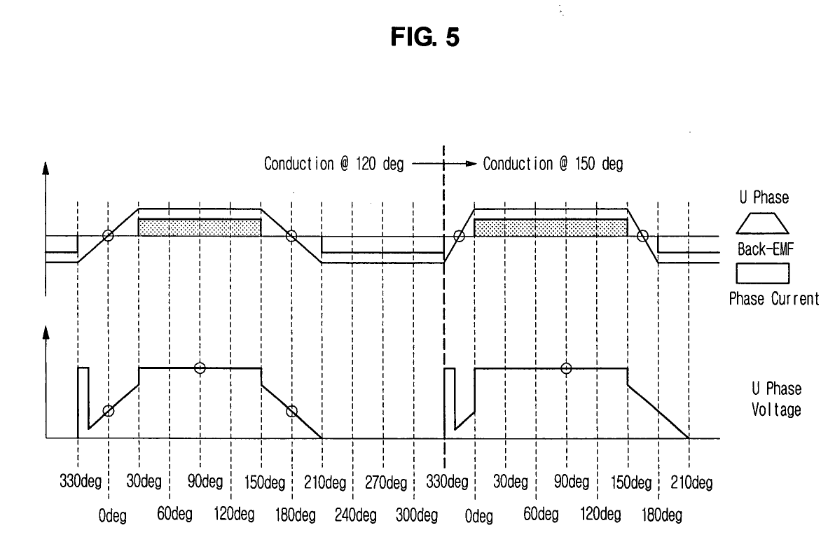

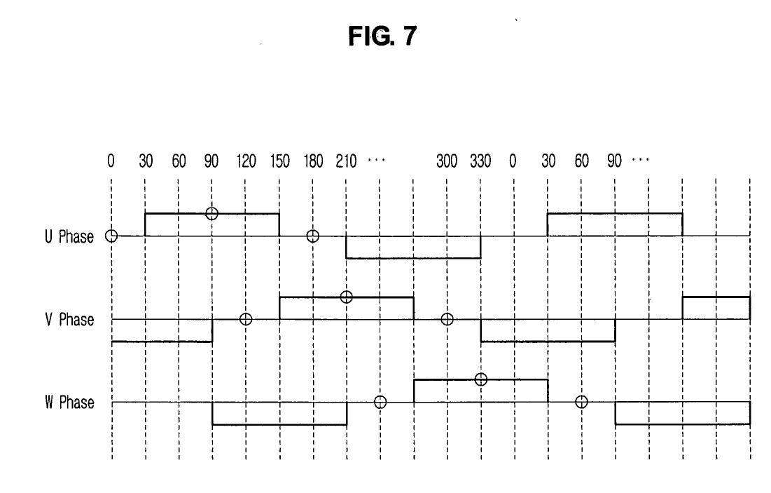

FIG. 5 shows graphs representing phase waveforms according to the change of a conduction interval (the change of the conduction interval means that an operational mode, that is, the driving speed of the BLDC motor, is changed). In FIG. 5,120-degree conduction represents a low-speed operational mode, and 150-degree conduction represents a high-speed operational mode. Since the low-speed operational mode shows a predetermined voltage value, that is, a half of the maximum phase voltage value at a 0 degrees in a left part of FIG. 5, an error occurrence probability is low when voltage is measured. However, because the high-speed operational mode shows both high and low points in the waveforms at the 0 degree point in a right part of FIG. 5, a probability of measuring the same voltage value is low when a measurement error and a voltage value are calculated. Accordingly, the 0 degree point is unsuitable for voltage measurement. For this reason, in order to improve the convenience and reliability for the calculation of a voltage ratio Rv, the maximum voltage value is measured at 90 degrees, and a half of the maximum voltage value is measured at 180 degrees in the U phase. However, a voltage measurement phase may be varied depending on products employing the BLDC motor, or the driving conditions of the BLDC motor 102. In addition, the voltage measurement phases may be variously designed and changed if another phase voltage (V-phase voltage, or W-phase voltage) (see FIG. 7) is applied to a stator of the BLDC motor 102. The measurement phases of the 90 and 180 degrees described above are for illustrative purposes only. Other measurement points are possible so long as it is possible to determine the suitability of a PWM duty based on terminal phase voltage of the stator and to perform compensation and control processes according to the determination result such that the controller 104 rotates the BLDC motor 102 at a desired speed.

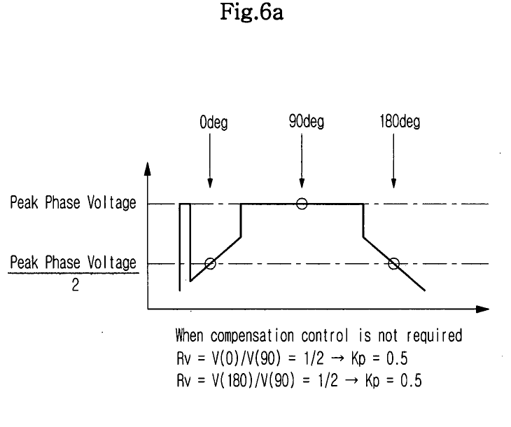

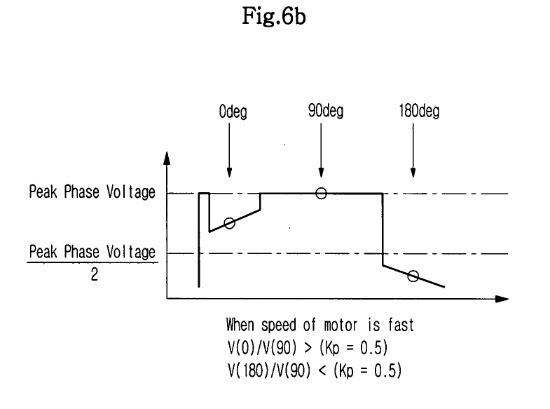

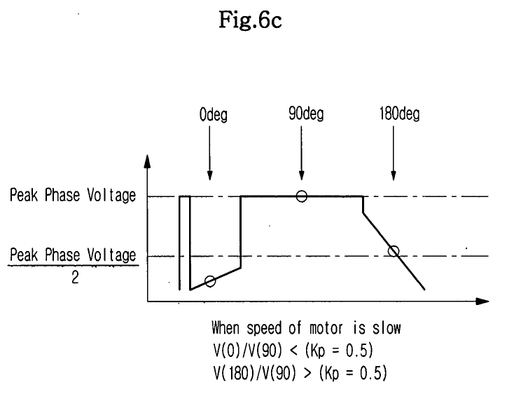

FIGS. 6a to 6c are graphs showing waveforms representing the relationship between a speed constant Kp and a voltage ratio Rv according to the driving speed of the BLDC motor 102. The speed constant Kp is defined as the ratio of voltage values at two phases when compensation and control processes are not required, that is, when the controller 104 rotates the BLDC motor at a desired speed. Therefore, the speed constant Kp may be varied according to voltage measurement phases.

According to the embodiment of the present invention, because the voltage measurement phases are set as a phase having the maximum voltage value and a phase having a half of the maximum voltage value, the speed constant Kp represents the ratio of 1 to 2 (1:2), that is, 0.5.

Since loads necessary for the BLDC motor 102 are frequently changed in products such as refrigerators and air conditioners employing the BLDC motor 102, a PWM duty must be compensated according to the loads whenever the loads are changed in order to drive the BLDC motor 102 at a desired speed.

FIGS. 6a to 6c show three waveforms according to the change of the loads. In the waveform of FIG. 6a, because the voltage ratio Rv is equal to the speed constant Kp, the controller 104 drives the BLDC motor 102 at a desired speed. Accordingly, compensation and control processes are not performed to change a PWM duty.

The waveform of FIG. 6b shows a state in which a load exerting an influence on the BLDC motor 102 is reduced, so that the driving speed of the BLDC motor is faster than a desired speed. It can be understood from the waveform of FIG. 6b that a voltage ratio Rv at 0 and 90 degrees is greater than a speed constant Kp, and a voltage ratio Rv at 90 and 180 degrees is smaller than the speed constant Kp. In this case, because the rotational speed of the BLDC motor 102 in driving is faster than a speed of the BLDC motor 102 required by the controller, compensation and control processes of decreasing a PWM duty are performed in order to reduce the driving speed of the BLDC motor 102.

The waveform of FIG. 6c has an inverse relationship with the waveform of FIG. 6b. In this case, because the driving speed of the BLDC motor 102 is slower than the speed required by the controller, the controller performs compensation and control processes of increasing the PWM duty in order to raise the driving speed of the BLDC motor 102.

FIG. 7 shows waveforms of three-phase currents (U, V, and W-phase currents) applied to the BLDC motor 102. Although a voltage measurement phase is described based on a U phase according to the embodiment of the present invention, the speed of the BLDC motor 102 may be compensated and controlled based on a V phase or a W phase. In the above description, 0, 90, and 180 degrees are described as examples of measurement phases to explain the phase having the speed constant Kp of 0.5. However, the voltage measurement is performed in measurement phases of 90 and 180 degrees while excluding the 0 degree point because the 0 degree point has a high probability of measurement error. As can be recognized from FIG. 7, if the above concept is applied to the V and W phases, the V phase has a speed constant Kp identical to that of the U phase at 210 and 300 degrees and the W phase has a speed constant Kp identical to that of the U phase at 330 and 60 degrees.

Hereinafter, a description will be made regarding operational procedures of the controller 104, which are performed by the controller 104 to realize a desired driving speed of a motor in the apparatus for controlling the BLDC motor 102.

Although it is necessary to employ an initial driving algorithm in order to drive a motor at the first stage, because there is no position information of a magnet of a stator regardless of the type of control, such an initial driving algorithm is a conventional technology used for the control of all BLDC motors. Accordingly, details of the initial driving algorithm will be omitted below.

In an operation of measuring the phase voltage, the phase voltage is measured at a phase of voltage applied to the stator of the BLDC motor from the inverter 101 in driving. The phase voltage is measured at 90 and 180 degrees of U phase in order to obtain a voltage ratio Rv. It can be understood that the voltage ratio Rv of 1:2 is equal to the speed constant Kp when the compensation and control processes are not required.

According to another embodiment of the present invention, because the controller 104 determines the execution of the compensation and control processes according to the voltage ratio Rv, plural pieces of information are obtained, and circuitry capable of calculating plural voltage ratios Rvs from plural phases is constructed with respect to U, V, and W phases such that the controller 104 can use the circuitry in order to enhance data reliability.

In the calculating of the voltage ratio Rv, because a lower voltage value is divided by a higher voltage value, a voltage value at 180 degrees is divided by a voltage value at 90 degrees according to one embodiment of the present invention. In an operation of comparing the voltage ratio Rv with the speed constant Kp, the voltage ratio Rv is compared with the speed constant Kp in order to determine whether the PWM duty is desirable. When the voltage ratio Rv for the 90 and 180 degrees is smaller than the speed constant Kp, because the driving speed of the BLDC motor is fast, the compensation and control processes are performed to decrease a PWM duty. In contrast, when the voltage ratio Rv is greater than the speed constant Kp, because the driving speed of the BLDC motor 102 is slow, the compensation and control processes are performed to increase the PWM duty. As a result, the BLDC motor 102 is driven at a speed required by the controller 104 even if a load is changed.

As described above, according to the embodiment of the present invention, because the controller 104 of the BLDC motor driving device allows the BLDC motor 102 to rotate at a desired speed even if loads exerting an influence on the driving speed of the BLDC motor 102 are changed, it is possible to reduce factors relative to the reliability of products, such as noises and vibration caused by phase voltage measurement errors and driving speed errors of the BLDC motor 102 in the conventional technology. In addition, according to the embodiments of the present invention, a portion of the circuits to obtain a position detection signal of a conventional rotor is removed, so that manufacturing costs can be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus controlling a brushless DC motor, the apparatus comprising:
a rectifier supplying DC power;
an inverter converting the DC power into AC power having a variable frequency in a shape of a pulse; and
a controller controlling the inverter, wherein suitability of a pulse width modulation duty relative to a driving speed of the brushless DC motor is determined with respect to voltage applied to a stator of the brushless DC motor based on a phase voltage measuring scheme of measuring voltage, and compensation and control processes for the brushless DC motor are performed according to the determining.

2. The apparatus as claimed in claim 1, wherein the phase voltage measuring scheme is to compensate and control the pulse width modulation duty by measuring a phase voltage, and the controller calculates a phase voltage ratio Rv in order to determine a driving speed of the brushless DC motor in driving and compares the phase voltage ratio Rv with a speed constant Kp.

3. The apparatus as claimed in claim 2, wherein the controller measures voltage twice per 360 degrees and divides a lower phase voltage value by a higher phase voltage value, thereby calculating the phase voltage ratio Rv.

4. The apparatus as claimed in claim 3, wherein the voltage is measured at 90 and 180 degrees.

5. The apparatus as claimed in claim 4, wherein the controller determines that the pulse width modulation duty has a relatively large value, and the brushless DC motor is driven at a speed faster than a desired speed, when the phase voltage ratio Rv is smaller than the speed constant Kp, and determines that the pulse width modulation duty has a relatively small value, and the brushless DC motor is driven at a speed slower than the desired speed when the phase voltage ratio Rv is greater than the speed constant Kp.

6. The apparatus as claimed in claim 5, wherein the controller performs the compensation and control processes by reducing the pulse width modulation duty when the pulse width modulation duty has the large value, and increasing the pulse width modulation duty when the pulse width modulation duty has the small value, such that the phase voltage ratio Rv is equal to the speed constant Kp.

7. A method of controlling a brushless DC motor in a system including a rectifier supplying DC power, an inverter converting the DC power into AC power having a variable frequency in a from of a pulse, and a controller performing a control process, the method comprising:
measuring a phase voltage applied to a stator of the brushless DC motor;
calculating a voltage ratio Rv from the measured phase voltage;
determining a pulse width modulation duty input to the inverter comprising comparing the voltage ratio Rv with a constant speed Kp; and
compensating and controlling the pulse width modulation duty according to the determining.

8. The method as claimed in claim 7, wherein, the measuring of the phase voltage comprises measuring the phase voltage at 90 and 180 degrees per 360 degrees.

9. The method as claimed in claim 8, wherein, the calculating the voltage ratio Rv, comprises dividing a voltage value at 180 degrees by a voltage value at 90 degrees.

10. The method as claimed in claim 9, wherein, the determining the pulse width modulation duty comprises determining that the pulse width modulation duty input to the inverter is greater than a pulse width modulation duty for a desired driving speed of the brushless DC motor when the voltage ratio Rv is smaller than the speed constant Kp, and determining that the pulse width modulation duty input to the inverter is smaller than the pulse width modulation duty for the desired driving speed of the brushless DC motor when the voltage ratio Rv is greater than the speed constant Kp.

11. The method as claimed in claim 10, wherein, the compensating the pulse width modulation duty comprises decreasing the pulse width modulation duty when the pulse width modulation duty has a relatively large value, and increasing the pulse width modulation duty when the pulse width modulation duty has a relatively small value.

12. A method of controlling a brushless DC motor, comprising:
converting DC power into AC power having a variable frequency in a shape of a pulse using an inverter;
determining a relationship between a pulse width modulation duty of the AC power relative to a driving speed of the brushless DC motor with respect to a voltage applied to a stator of the brushless DC motor; and
compensating and controlling the brushless DC motor according to the determining.

13. The method of claim 12, wherein the determining comprises determining the voltage according to a phase voltage measuring scheme.
